(19) United States
(12) Patent Application Publication
(10) Pub. No.: US 2004/0249935 A1
(43) Pub. Date: Dec. 9, 2004

(54) Method for providing real-time monitoring of components of a data network to a plurality of users

(76) Inventors: Juneko Jackson, Singapore (SG); Balamurugan Vaidhinathan, Chennai (IN)

Correspondence Address: Intellectual Property Law Group, Twelfth Floor, 12 South First Street, San Jose, CA, 95113, US

(21) Appl. No.: 10/486,404

(22) PCT Filed: Aug. 1, 2002
(86) PCT No.: PCT/SG02/00173

(30) Foreign Application Priority Data
Aug. 6, 2001 (SG) 0104674-7

(51) Int. Cl. G06F 15/173

(52) U.S. Cl. 709/224; 709/223

(57) ABSTRACT

A method is disclosed for providing real-time monitoring of components of a data network to a plurality of users. A manager gathers data regarding said components and analyses said data to determine the status of each component. Each user is associated with a communications address and a subscription period, and is allocated user permissions to access said data and the status of the components. If the subscription period associated with a user has not expired, the user is provided with real-time access to said data and the status of the components in accordance with said user's permissions, and is notified using the communications address associated with said user of any alarm states that occur in components that the user has permission to access. The manager analyses the data without regard to said user permissions.

### FIELD OF THE INVENTION

This invention relates to providing real-time monitoring of components of a data network to a plurality of users. The invention has particular, although not exclusive, utility in relation to providing real-time monitoring of components of a data network with shared components to a plurality of users.

### BACKGROUND ART

Recent years have witnessed a radical shift in the way Internet servers are operated and managed. Large and small corporations and enterprises alike have begun to outsource the hosting of their servers with specialized Internet Data Centers (IDC) and Application Service Providers (ASPs).

An ASP provides the hardware, the network and software infrastructure that is required to operate an Internet service. The hardware provided by the ASP includes Internet servers which host services for the customer. While the ASP is responsible for the hardware, the network and the software infrastructure, the customer is responsible for the actual service operating on the hosted servers.

In the case of an IDC, the Internet servers may be provided by the IDC or by the customer. The customer is also responsible for the software platform and the actual service operating on the hosted servers.

The presence of multiple, independent domains of control and responsibility poses interesting challenges in operating and maintaining outsourced Internet services.

Monitoring systems are used to provide information on the status of hardware, network and/or software systems to assist in addressing these challenges. This has led to the growth of MSPs (Management Service Providers) that offer monitoring services for hosted environments. MSPs do not provide hardware, network or software platforms but offer to monitor existing systems.

Monitoring systems for various data networking environments have been the subject of much research In the past. Many popular monitoring systems have been developed for network monitoring. These systems mainly track network connectivity and usage of various network elements such as routers, switches, hubs, etc. To track the CPU, memory, and various I/O statistics of the different hosts servers in a networked environment, system monitoring solutions have been developed.

With the advent of software solutions to facilitate conducting business transactions over a data network (eBusiness solutions), the complexity of applications supported in a networked environment has increased dramatically. While networks and systems monitoring has been relatively well understood over the years, the advent of new multi-tier application development platforms and software environments has turned the focus to the development, deployment, and maintenance of eBusiness applications. In the recent past, monitoring systems that provide integrated monitoring of networks, systems, as well as applications have been the subject of attention.

A great majority of monitoring solutions follow the manager-agent architecture. As per this architecture, software agents deployed on the various hosts of a networked environment make periodic measurements that are reported to a central manager. To collect measurements, the agents use various tests. A test can make multiple measurements. For example, a Process Test can report measurements that indicate the number of processes that are running, and the CPU and memory utilization of the running processes.

FIG. 1 shows an example of an e-business system. To ensure redundancy, the system uses multiple Internet Service Providers (ISPs) 10, 12, and 14 to connect to the Internet. An access router 16 manages the connectivity to the ISPs. At least one load balancer 18 is responsible for receiving user requests via the ISP s and directing the requests to one of the available web servers 20, 22 and 24 used by the system. The web servers forward the Incoming requests to the appropriate E-business applications. The E-business applications execute on middleware platforms commonly referred to as application servers 26 and 28. A firewall 30 is used to provide security.

The application servers 26 and 28 enable a number of features from which different applications can benefit. These features include optimisation of connections to database servers 32, 34 and 36, caching of results from database queries, and management of user sessions. Data that is indicative of user information, a catalog of goods, pricing information, and other relevant information for the E-business system is stored in the database servers and is available for access by the application components. To process payments for goods or services by users, the system maintains connections to at least one remote payment system 38. Links to shipping agencies 40 are also provided, so as to enable the E-business system to forward the goods for shipping as soon as an order is satisfied.

Also shown in FIG. 1 are a Domain Name Service (DNS) server 42 and a Wireless Application Protocol (WAP) server 44, and Lightweight Directory Access Protocol (LDAP) server 45. As is known in the art, the DNS server is accessed to provide users with the Internet Protocol (IP) address. The WAP server may be used for frontending applications accessed via wireless devices such as mobile phones and Personal Digital Assistants (PDAs), while the LDAP server is used for storing and retrieving information in a directory format.

As compared to the emphasis on design issues of the E-business system, monitoring and managing issues for such systems have received significantly less attention. Many systems are managed using ad-hoc methods and conventional server and network monitoring systems, which are not specifically designed for an E-business environment. As a result, the monitoring capabilities are limited.

Since the business applications of a system rely on application servers for their operation, the application servers 26 and 28 are in a strategic position to be able to collect a variety of statistics regarding the health of the E-business system.

The application servers can collect and report statistics relating to the system's health. Some of the known application servers also maintain user profiles, so that dynamic content (e.g., advertisements) generated by the system can be tailored to the user's preferences, as determined by past activity. However, to effectively manage the system, monitoring merely at the application servers is not sufficient. All the other components of the system need to be monitored and an integrated view of the system should be available, so that problems encountered while running the system (e.g., a slowdown of a database server or a sudden malfunction of one of the application server processes) can be detected at the outset of the problem. This allows corrective action to be initiated and the system to be brought back to normal operation.

FIG. 1 also illustrates monitoring components used with the E-business system shown in FIG. 1. The core components for monitoring include a manager 46, internal agents 48, 50 and 52, and one or more external agents 54. The manager of the monitoring system is a monitoring server that receives information from the agents. The manager can provide long-term storage for measurement results collected from the agents. Users can access the measurement results via a workstation 56. For example, the workstation may be used to execute a web-based graphical user interface.

As is known in the art, the agents 48, 50, 52 and 54 are typically software components deployed at various points in the E-business system. In FIG. 2, the internal agents are contained within each of the web servers 20, 22 and 24, the application servers 26 and 28, and the LDAP server 45. By running pseudo-periodic tests on the system, the agents collect information about various aspects of the system. The test results are referred to as “measurements” The measurements' may provide information, such as the availability of a web server, the response time experienced by requests to the web server, the utilization of a specific disk partition on the server, and the utilization of the central processing unit of a host. Alternatively, tests can be executed from locations external to the servers and network components. Agents that make such tests are referred to as external agents. The external agent 54 is shown as executing on the same system as the manager 46. As previously stated, the manager is a special monitoring server that Is installed in the system for the purpose of monitoring the system. The external agent 54 on the server can Invoke a number of tests. One such test can emulate a user accessing a particular website. Such a test can provide measurements of the availability of the website and the performance (e.g., in terms of response time) experienced by users of the website. Since this test does not rely upon any special instrumentation contained within the element being measured, the test is referred to as a “black-box test”.

Often, it is more efficient to build instrumentation into the E-business elements and services. For example, database servers 32, 34 and 36 often support Simple Network Management Protocol (SNMP) interfaces, which allow information to be obtained about the availability and usage of the database server. An external agent, such as agent 54, may execute a test that issues a series of SNMP queries to a particular database server to obtain information about the server's health. Since such a test relies on instrumentation built into the database server, tests of this type are referred to as “white-box tests”

External agents 54 may not have sufficient capability to completely gauge the health of an E-business system and to diagnose problems when they occur. For example, it may not be possible to measure the central processing unit utilization levels of a web server from an external location. To accommodate such situations, the monitoring system can use the internal agents 48, 50 and 52.

The manager software is responsible for database storage of the measurements reported by the agents, analysis of the stored data, and for the correlation of the reported measurements to identify when problems occur in the monitored environment and what the root-causes of problems may be. Various protocols such as the Simple Network Management Protocol (SNMP) or the Hyper Text Transfer Protocol (HTTP) have been used for manager-agent communications. Prior efforts have focused on algorithms and heuristics that can be built into the manager software in order to detect and report problems accurately.

Traditionally, monitoring systems have been viewed as a cost-center, being mostly used to improve the efficiency and internal operations of enterprises, corporate IT departments, and ASPs and IDCs. Since most monitoring systems are internally focused, IDCs and ASPs have used these systems primarily for their internal operations. Typically, customers of an IDC or ASP do not have a real-time view of the status and performance of their services and servers. Instead, they have to be content with weekly and monthly reports mainly focused on server and network usage.

The challenges in monitoring hosted environments result mainly from:

The hosting provider (IDC or ASP) owning the network, hardware, and the operating system components, while the customer owns the application components. Since the performance of the application depends on the network and system components, there is frequently a tendency for the customer to blame the IDC or ASP for a problem, and vice versa. Faced with severe competition, the hosting providers have had to expend a lot of resources in troubleshooting customer problems. Consequently, their support costs tend to be high.

A second complication in hosted environments results from the fact that different customer web sites and eBusinesses can be hosted in the same network. Sometimes, different eBusiness sites may even be supported on the same system (such a configuration is often referred to as shared hosting). Usage, performance, and availability measurements pertaining to a customer's eBusiness is perceived as being sensitive information that cannot be revealed or shared with other customers.

Most existing monitoring solutions do not handle the challenges posed by the multi-domain nature of hosted environments.

Faced with severe competition, many hosting providers are looking to offer monitoring and management services of the hosted environment as value-added services to their customers.

Many IDCs and ASPs are retrofitting existing monitoring solutions to meet these needs. To address the above needs, IDCs and ASPs use one manager for each customer being supported in the hosted environment, to ensure the security of each customer's data.

The drawbacks of this approach are:

The need to own and operate multiple managers. Each manager is typically an expensive software component. Moreover, separate hardware is required to host each manager. The need for multiple independent managers makes the overall solution very expensive.

The agents may also have to be independent software components reporting to the different managers, so as to preserve the security of each customer's data.

### DISCLOSURE OF THE INVENTION

Throughout the specification, unless the context requires otherwise, the word “comprise” or variations such as “comprises” or “comprising”, will be understood to imply the inclusion of a stated integer or group of integers but not the exclusion of any other integer or group of integers.

According to the present invention, there is provided a method for providing real-time monitoring of components of a data network to a plurality of users, in which a manager gathers data regarding said components and analyses said data to determine the status of each component, said method comprising the steps:

Associating each user with a communications address and a subscription period;

Allocating to each user permissions to access said data and the status of the components;

If the subscription period associated with a user has not expired: providing said user with real-time access to said data and the status of the components in accordance with said user's permissions; and

notifying said user, using the communications address associated with said user, of any alarm states that occur in components that the user has permission to access as each alarm state occurs; and

Performing said analysis of said data by said manager without regard to said user permissions.

Preferably, said user permissions include the ability to configure agents that provide data to said manager concerning a component.

Preferably, the step of allocating permissions comprises arranging said users in a hierarchical manner, whereby each user inherits the permissions to access said data and the status of the components of other users that are beneath them in the hierarchy.

Preferably, the user permissions include the ability to provide restrictions on the configuration of agents by other users that are beneath them in the hierarchy.

Preferably, the components include network, system and application elements, and the analysis of the data includes correlation of the state of the elements to determine the status of each component.

Preferably, the method further comprises the step of sending each user an alarm regarding the impending expiry of their subscription period.

Preferably, the method further comprises the step of providing each user with real-time access to current alarms and an alarm history for that user.

Preferably, the data and said status of said components is provided to each user via a user interface, said method further comprising the step of providing user preferences regarding the presentation of said data and said status of said components in said user interface.

Preferably, the user preferences include alarm preferences determining the manner in which alarms are notified to said user according to an alarm's state and the corresponding component.

Preferably, there are at least two data networks having with different network address ranges, said method further comprising the step of providing at least one agent in each data network that communicates with the manager to provide data to the manager, and said step of performing said analysis of said data by said manager is performed on said data from all data networks.

Preferably, the manager comprises a single, central manager, or a multiplicity of independent managers.

In accordance with another aspect of the present invention, there is provided a system for providing real-time monitoring of components of a data network to a plurality of users, said system comprising:

manager means arranged to gather data regarding said components and analyse said data to determine the status of each component;

user management means provided in said manager, arranged to store and configure profile information regarding each user, said profile information including a communications address and a subscription period, user permissions to access said data and the status of the components;

user service means responsive to each user, and arranged to interface with the manager, said user service means arranged to confirm that the subscription period for a user has not expired, and if said subscription period has not expired, to provide said user with real-time access to said data and the status of the components in accordance with said user's permissions, and to notifying said user, using the user's communications address, of any alarm states that occur in components that the user is associated with as each alarm state occurs;

said manager being arranged to analyse said data by without regard to said user permissions.

Preferably, the user permissions Include the ability to configure agents that provide data to said manager concerning a component.

Preferably, the user management means is arranged to arrange said users in a hierarchical manner, whereby each user inherits the permissions to access said data and the status of the components of other users that are beneath them in the hierarchy.

Preferably, the user permissions include the ability to provide restrictions on the configuration of agents by other users that are beneath them in the hierarchy.

Preferably, the components include network, system and application elements, and the analysis of the data includes correlation of the state of the elements to determine the status of each component.

Preferably, the user service means is arranged to notify each user regarding the impending expiry of their subscription period.

Preferably, the user service means is arranged to provide each user with real-time access to current alarms and an alarm history for that user.

Preferably, the user service means is arranged to provide each user with information via a user interface, said user service means arranged to provide user preferences regarding the presentation of said data and said status of said components in said user interface.

Preferably, the user preferences include alarm preferences determining the manner in which alarms are notified to said user according to an alarm's state and the corresponding component.

Preferably, there are at least two data networks having with different network address ranges, said system further comprising at least one agent means in each data network that communicates with the manager means and arranged to provide data to the manager means, said manager means being arranged to analyse said data from all data networks.

Preferably, the manager means comprises a single, central manager.

Preferably, the manager means comprises a multiplicity of independent managers.

### BRIEF DESCRIPTION OF THE DRAWINGS

FIG. 1 is a schematic illustration of a system of the prior art;

FIG. 2 is a schematic illustration of an embodiment of a system in accordance with the invention; and

FIG. 3 is a block diagram of the central manager used in the system of FIG. 2.

### BEST MODE(S) FOR CARRYING OUT THE INVENTION

The embodiment of the invention is directed towards a method and system for providing real-time monitoring of components of several data networks to users of those data networks. The system utilises a single, central manager to provide real-time monitoring of all of the data networks, which allows the cost of the manager to be amortized amongst all of the users. Although the manager is used to monitor several data networks, the privacy of each users data is maintained by appropriate permissions-based access. The manager itself, however, is able to analyse the data gathered from all of the data networks in order to determine the cause of any problems occurring in the data networks without regard to user permissions, enabling the superior analysis of the cause of any problems that occur in any of the data networks compared to existing solutions.

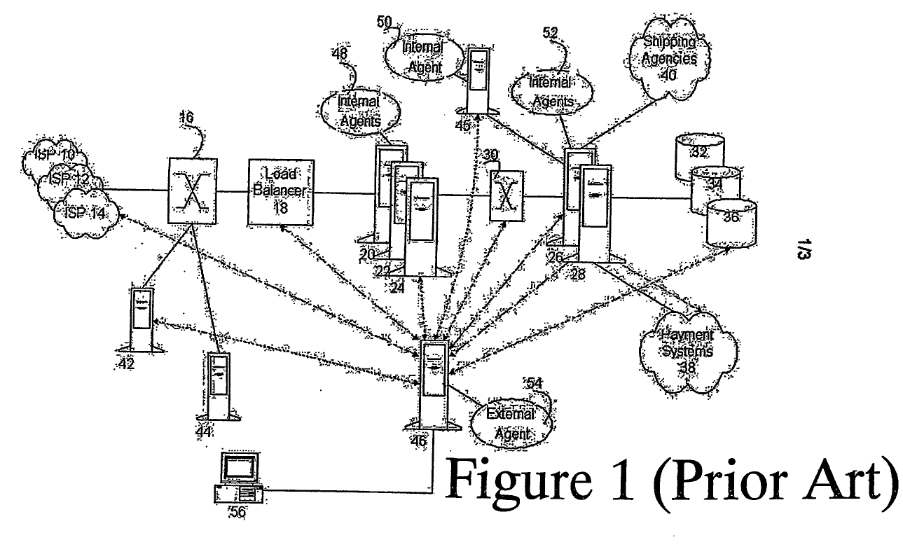

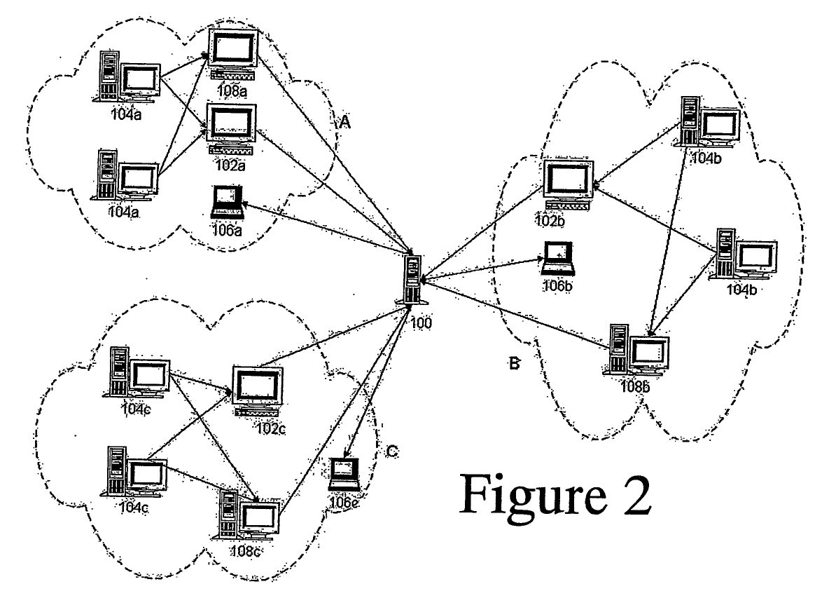

FIG. 2 shows one possible configuration of the system of the embodiment. The system comprises a central manager 100 that is responsible for monitoring three data networks A, B and C, respectively. In practice, each of the networks A, B and C will have a configuration similar to that shown in FIG. 1. For the sake of clarity in FIG. 2, the network A is represented by an external agent 102A, an internal agent 108A, application servers 104A and a workstation 106A. The networks B and C are represented in FIG. 2 in a similar manner to network A, with like reference numerals denoting like parts with the suffix “A” replaced with “B” and “C”, respectively. While FIG. 2 shows one external agent being used per customer network being monitored, this Is not a requirement. The same external agent may also be used to monitor components In different customer networks. Multiple external agents located in different remote locations can also be used to monitor a single customer network. The main advantage of such a configuration is that it allows external monitoring from multiple perspectives, for example with respect to the response time for a web site from San Francisco versus Sydney. As mentioned above, each customer network A, B, C can also include internal agents 10BA, 108B, and 108C. There can also be more than one internal agent for each network—although only one is shown, for clarity.

The networks A, B and C may each represent an IDC that, in turn, hosts services for its customers. Alternatively, or in combination, the networks A, B and C may each represent divisions of a corporation's network. Further, each of the networks A, B and C may be physically and logically separate, or they may physically or logically share some components such as connection to ISPs.

In another deployment, the networks A, B and C may also represent multiple IDC's being managed by an MSP.

The internal and external agents 102A, 102B, 102C; 108A, 108B, 108C may be running on hosts that have private address, and, therefore, each network A, B, C may have its own distinct set of addresses. In this case, communication will have to be done through a proxy server, or firewall (not shown). All communication between the central manager 100 and the external and Internal agents is based on a “pull” model, with agents 102A, 102B, 102C; 108A, 108B, 108C pulling configurations from the central manager 100 (as opposed to the central manager 100 pushing configurations to the agents 102A, 102B, 102C; 108A, 108B, 108C). The external and internal agents 102A, 102B, 102C; 108A, 108B, 108C communicate directly with the central manager 100, forwarding data back to the manager and detecting and reacting to any configuration changes.

The central manager 100 Is not Itself provided in a private network, so that the workstations 106A, 106B and 106C can be used by users of each network A, B and C to access the central manager 100 and obtain real-time information on the status of components of the relevant data network of interest to them, as described in further detail below.

Rather than using a single central manager 100, the management functionality can be implemented by a collection of independent managers. In this embodiment, at the time of installation, the agents can be configured to communicate with a specific manager. Alternatively, using well understood load balancing techniques, a collection of managers can be made to present a unified interface to the agents (and to the different types of users as well).

The operation of the monitoring system of the embodiment is not restricted to any form or configuration of the networks A, B and C. The single, central manager 100 is able to monitor each of the networks A, B and C in real-time, using the information received from the external agents 102A, 102B and 102C and to provide alerts to appropriate users concerning problems that occur in any of the networks A, B and C while protecting the privacy of each network owner, such as an IDC, and of the customers of the network owner.

Although the manager 100 provides users with restricted access to data it receives from the external agents 102A, 102B and 102C according to that users privileges, the manager 100 itself is able to analyse and correlate all of the received information, irrespective of user privacy. This allows the manager 100 to more accurately determine the root cause of a problem compared with existing solutions where the manager may only have access to those components of a network that are relevant to a user. In addition to allowing for the better analysis of problems that may occur In any of the networks, this arrangement also avoids the generation of spurious alert messages to users where the root cause of a problem lies with a component outside of their influence.

Advantageously, existing agents, both internal and external, can be used with the manager 100 of the embodiment without modification. The agents continue to be responsible for collecting and reporting a variety of measurements to the manager 100.

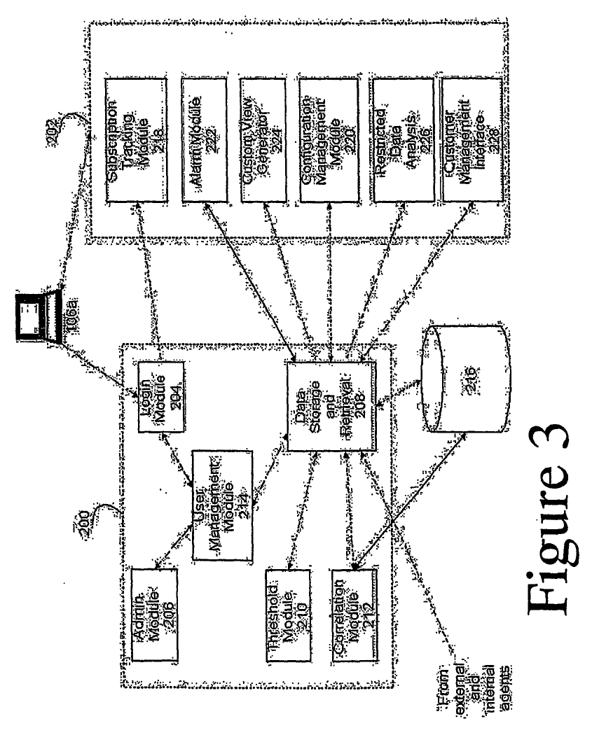

FIG. 3 shows a block diagram of the central manager 100. In the embodiment, the central manager 100 is implemented as a main manager component 200 and a plurality of virtual manager components 202.

The main manager component 200 implements the core functions of the manager 100, such as the receipt and storage of the measurement data from the external agents 102A, 102B and 102C, threshold computation for the collected measurement results, analysis of the stored data for trending and service-level audits, alarm correlation for root-cause diagnosis, user log in and administration.

A virtual manager component 202 is provided for each user. Each virtual manager component 202 is responsible for providing customised displays of, for example, that user's hosted environment to the user. Each virtual manager component 202 is also responsible for subscription and licence tracking for that user and for the generation and communication of alerts in real-time to the user. Each virtual manager component 202 interfaces with components of the main manager component 200.

The virtual manager components 202 can be implemented in various ways, for example as separate processes, or as individual threads of the main manager 200 process, within the context of the main manager 200 process itself. It would also be apparent to a person skilled in the art that it would be possible to implement the main manger module 200 and the virtual manager components 202 as a single module.

However, providing the virtual manager components 202 as separate to the main manager component 200 provides an advantage in that the virtual manager components 202 can be used with any suitable main manager component 200, provided that it supports the necessary interface to the virtual manager components 202. Thus, the monitoring system of the embodiment can be implemented with existing manager components to expand the capability of those managers, provided that the necessary interface capabilities are met.

One manager component that is particularly suitable is described in the applicant's co-pending U.S. patent application Ser. No. 09/750,890, the entire disclosure of which is incorporated herein by reference.

Broadly speaking, the main manager component 200 will consist of the following general components: a user management module 214, a log In module 204, an administration module 206, a data storage and retrieval module 208, a threshold module 210, and a correlation module 212.

The user management module 214 provides the functionality for aiding and deleting users to the manager 100 as well as updating each user's profile. The central manager 100 can support a number of different types of user, for example, in the embodiment described herein, there are administrative users, customer users and a global monitor user. However, other types of users can also be supported.

Administrative users are the super-users of the central manager 100. Multiple administrative users can be configured, however, all administrative users have the same rights. Each administrative user can select what hardware and application servers are to be monitored by the manager 100, where the agents should be executed to monitor the networks A, B and C, what tests these agents should run, and how often these tests should be performed. Administrative users also have the ability to add and delete other users to the system and to configure their privileges. Further, administrative users are responsible for establishing and configuring the server and site topologies or whatever other information is required by the main manager component 200 to be able to analyse the data received from the external agents 102A, 102B and 102C.

Customer users have restricted access to the manager 100. In this context, a customer user may include the owner of each network A, B and C along with each network owner's own customers. For example, if the network A was owned by an IDC which hosted applications for its customers, both the IDC and the IDC's customers would constitute customer users of the manager 100.

Each customer user has a profile stored in a database 216 on the manager 100. Each user's profile Includes a communication address where alarms will be forwarded. In the embodiment, the communication address comprises an e-mail address however other communication mediums could also be supported without difficulty such as short messaging system (SMS) to cellular telephones. Each user's profile also includes alarm preference information indicating whether alarm indications are to be transmitted in plain text or HTML format, whether a complete list of outstanding alarms is to be generated and forwarded to the user each time a new alarm occurs or whether the new alarm alone should be transmitted to the user, whether the complete list is to be arranged by alarm priority or in order of occurrence, and so forth.

Each customer user's profile includes subscription information defining a period during which the customer user has valid access to the manager 100.

When new customer users are added to the manager 100 by an administrative user, the administrative user specifies a set of web sites that the user has monitoring access to. In the embodiment, the server topology defined for each network A, B and C in the main manager component 200 has each website associated with one or more other servers, for instance a website can be associated with a web server, a web application server, and a database server. A customer user who has rights to monitor a website is automatically granted rights to monitor all of the servers associated with the website in the server topology. In addition to monitoring websites, there may be other application servers or network components that may not be part of a sites topology, but which a customer user may wish to monitor. For example, a customer user may wish to monitor a DNS server, in addition to their website. The administration module 206 allows the administrative user to associate multiple independent servers with each customer user's profile.

Further, in the embodiment, customer users are arranged in a hierarchical manner. Each customer user Is positioned within the hierarchy when they are added to the manager 100. Customer users automatically inherit the privileges of each user beneath them in the hierarchy, Including the ability to access their information and alarms. Thus, if the owner of network A is an IDC, the IDC can be created as a user of the manager 100, with each of the IDC's customers created as users beneath the IDC user, such that the IDC user would be able to view alarms for each of its customers, but each of its customers would not be able to view alarms or information of any of its other customers.

The administrative user can also assign each customer user with the ability to configure, to a limited extent, the operation of some agents. For instance, where an application server within a network is a dedicated application server for that customer user, such as a dedicated web application server, the customer user may be granted the ability to configure the frequency within which the internal agent of that application server operates. Note that the administrative user may set a parameter range within which the customer user can configure the operation of the agent, such as specifying that the tests must be performed at least once every five minutes but otherwise allowing the customer user the ability to specify the frequency with which the tests occur. Further, the administrative user may provide each customer user with the ability to provide restrictions on the ability of users beneath them in the hierarchy to configure that same agent.

The global monitor user has an overall perspective of the main manager 100 but does not have the administrative powers provided to an administrative user. A global monitor user can view all data concerning one of the networks A, B or C, can view all reports generated regarding that network and receive all alarms pertaining to that network.

The log in module 204 receives Initial requests to log in from customer users operating on workstations 106A, 106B or 106C. The log in module 204 verifies that the provided password and user name is correct, identifies the corresponding virtual manager component 202 and notifies the virtual manager component 202 of the attempted log in by the customer user. The virtual manager component is then responsible for providing information to and responding to requests from the customer user as will be described in detail below.

The administration module 206 is used by administration users and provides the functionality to configure the data networks to be monitored, such as specifying the various services and hardware topology that comprise each data network and the interdependencies among them, configuring where the internal and external agents should execute, the tests that each agent should run and the frequency of performing each test, specify parameters for each test and configuring websites and individual user transactions that are to periodically monitored. For example, for a retail web site, the key transactions performed by a user include registration, login, browsing the product catalogue, adding to the shopping cart, deleting items from the shopping cart, payment, shipping etc.

The data storage and retrieval module 208 is responsible for receiving measurement results from the external agents 102A, 102B and 102C and for storing the results in the relational database 216.

The threshold module 210 is responsible for analysing the measurement data and comparing it with thresholds that are used to determine whether a measurement is within a normal range or not. Any suitable thresholding policy may be used, as desired. As part of this analysis process, hourly, daily and monthly trends can be computed and stored in the database 216 for historical analysis.

The correlation module 212 is responsible for analysing and correlating measurements received from the external agents 102A, 102B and 102C to provide instantaneous diagnosis of root causes of problems that occur.

The virtual manager component 202 includes a subscription tracking module 218, a configuration management module 220, an alarm module 222, a custom view generator 224 and a restricted data analysis module 226.

The subscription tracking module 218 receives notification from the main manager component 200 log in module 204 that the customer user is attempting to log in.

The subscription tracking module 218 then determines whether the subscription period for the customer user is still valid, and hence whether the customer user Is permitted access to the central manager 100. In addition, the subscription tracking module 218 automatically generates an alarm for the customer user as their subscription period approaches expiry.

The configuration management module 220 provides the customer user with the ability to perform configuration tasks of agents within the restrictions imposed by the administration user. For instance, a customer user can be allowed to configure which specific transactions will be monitored for a website according to that users requirements by an internal agent. This not only provides the customer user with flexibility in configuring the monitoring of their website, but also relieves some administration burden from the administrative users. Configuration changes made by the customer user are communicated by the configuration management module 220 to the data storage and retrieval module 208 of the main manager component for storage in the database 216.

The alarm module 222 is responsible for determining whether any new alarms are relevant to the customer user based on measurements and analysis from the database 216, and for forwarding such alarms to the customer users nominated communication address. This ensures that a customer user is alerted promptly when a problem is detected. The alarm module 222 is also responsible for ensuring that a customer user is sent alarms relating only to the states of websites and/or other servers or network components that the user has access permission to according to the permissions configured by the administrative user. In addition to communicating alarms immediately to the customer user via their communication address, the alarm module 222 is also able to provide a current and historical record of alarms to the user via a web interface. The alarm module 222 communicates directly with the data storage and retrieval module 208 of the main manager component 200. Alarms are stored in the database 216 by the Correlation Module 212 of the main manager component 200.

The custom view generator 224 is responsible for composing personalised views of information obtained from the database 216 via the data storage and retrieval module 208 of the main manager component 200 and presenting it to the customer user. The custom view generator 224 is responsible for ensuring that the customer user if only provided with information that their privileges allow them to access. The views available to the user include the states of each of the websites and servers or other network components that the user has privileges to access. Further, the custom view generator 224 is responsible for displaying the information based on the user's preferences, Including the time zone that the user wishes to view the information. Thus, although the measurement data may be collected in Pacific Standard Time, the custom view generator allows the user to view the data in GMT, for Instance. This is particularly useful in situations where the customer user is located in one geographic region but is monitoring websites and application servers located in another geographical region via the Internet.

The restricted data analysis module 226 provides the customer user with functionality to analyse the measurement results in the database 216, access servers-level audits and view trends calculated by the threshold module 210 of the main manager component 200, within the restrictions provided by the administrative user. Thus, the customer user may only perform data analysis on those websites and servers that they have permission to access, and may only have access to a subset of the range of audits, trends and reports generated within the main manager component 200. The latter would particularly be the case in a shared hosting environment where multiple customers shared one or more application servers. Whilst each customer user may be entitled to pool information concerning their website, they may be provided with access to some form of reports and audits conducted on the shared application server if such reports contained information or statistics regarding other customer users.

The customer management interface 228 provides an application programming interface that can be incorporated into an IDC or ASP billing and customer management system, so that as and when a user subscribes to or renews their subscription to the monitoring system, the billing and customer management system can communicate with the customer management interface 228 and automatically extend a user's subscription by updating the subscription information in the user's profile. This provides a very convenient mechanism for IDCs and ASPs to transparently provide a monitoring service to their customers and incorporate the same into their billing system without needing to implement a monitoring solution separately for each user.

As will be appreciated from the foregoing description, the monitoring system of the embodiment allows for the amortization of the hardware and software costs of monitoring amongst many customer users. Further, for network owners such as IDCs and ASPs, the monitoring system of the embodiment can become a revenue generating facility rather than a cost centre, and can be used to improve the efficiency of their operations.

Importantly, the monitoring system provides users with current, real-time status information regarding their websites and associated servers through a configurable web-based browser interface.

It should be appreciated that the scope of this invention is not limited to the particular embodiment described above. For example, although the description above has described several networks, the hosting environment could have a single IP address range. The hosts in this range could be in different domain name spaces, but may be owned and administered by different sets of personnel.

1. A method for providing real-time monitoring of components of a data network to a plurality of users, in which a manager gathers data regarding said components and analyzes said data to determine a status of each component, said method comprising the steps of:
associating each user with a communications address and a subscription period;
allocating to each user, permissions to access said data and the status of the components; if the subscription period associated with a user has not expired:
providing said user with real-time access to said data and the status of the components in accordance with said user's permissions; and
notifying said user, using the communications address associated with said user, of any alarm states that occur in components that the user has permission to access as each alarm state occurs; and
performing said analysis of said data by said manager without regard to said user permissions.

2. The method of claim 1, wherein said user permissions include the ability to configure agents that provide data to said manager concerning a component.

3. The method of claim 2, wherein said step of allocating permissions comprises arranging said users in a hierarchical manner, whereby each user inherits the permissions to access said data and the status of the components of other users that are beneath them in the hierarchy.

4. The method of claim 3, wherein said user permissions include the ability to provide restrictions on the configuration of agents by other users that are beneath them in the hierarchy.

5. The method of any one of claims 1 to 4, wherein the components include network, system and application elements, and the analysis of the data includes correlation of states of the elements to determine the status of each component.

6. The method of any one of claims 1 to 4, further comprising the step of notifying each user regarding the impending expiry of their subscription period.

7. The method of any one of claims 1 to 4, further comprising the step of providing each user with real-time access to a plurality of current alarms and an alarm history for that user.

8. The method of any one of claims 1 to 4, wherein said data and said status of said components is provided to each user via a user interface, said method further comprising the step of providing user preferences regarding a presentation of said data and said status of said components in said user interface.

9. (canceled)

10. The method of any one of claims 1 to 4, wherein there are at least two data networks having different network address ranges, said method further comprising the step of providing at least one agent in each data network that communicates with the manager to provide data to the manager, and said step of performing said analysis of said data by said manager is performed on said data from all data networks.

11. The method as claimed in any one of claims 1 to 4, wherein the manager comprises a single, central manager.

12. The method as claimed in any one of claims 1 to 4, wherein the manager comprises a multiplicity of independent managers.

13. A system for providing real-time monitoring of components of a data network to a plurality of users, said system comprising:
a manager means arranged to gather data regarding said components and analyze said data to determine a status of each component;
a user management means provided in said manager means, arranged to store and configure profile information regarding each user, said profile information including a communications address and a subscription period, user permissions to access said data and the status of the components;
a user service means responsive to each user, and arranged to interface with the manager means, said user service means arranged to confirm that the subscription period for a user has not expired, and if said subscription period has not expired, to provide said user with real-time access to said data and the status of the components in accordance with said user's permissions, and to notifying said user, using the user's communications address, of any alarm states that occur in components that the user is associated with as each alarm state occurs;
said manager means being arranged to analyze said data by without regard to said user permissions.

14. The system of claim 13, wherein said user permissions include the ability to configure agents that provide data to said manager means concerning a component.

15. The system of claim 14, wherein said user management means is arranged to arrange said users in a hierarchical manner, whereby each user inherits the permissions to access said data and the status of the components of other users that are beneath them in the hierarchy.

16. The system of claim 15, wherein said user permissions include the ability to provide restrictions on the configuration of agents by other users that are beneath them in the hierarchy.

17. The system of any one of claims 13 to 16, wherein the components include network, system and application elements, and the analysis of the data includes correlation of states of the elements to determine the status of each component.

18. The system of any one of claims 13 to 16, wherein the user service means is arranged to notify each user regarding the impending expiry of their subscription period.

19. The system of any one of claims 13 to 16, wherein the user service means is arranged to provide each user with real-time access to a plurality of current alarms and an alarm history for that user.

20. The system of any one of claims 13 to 16, wherein the user service means is arranged to provide each user with information via a user interface, said user service means arranged to provide user preferences regarding a presentation of said data and said status of said components in said user interface.

21. (canceled)

22. The system of any one of claims 13 to 16, wherein there are at least two data networks having different network address ranges, said system further comprising at least one agent means in each data network that communicates with the manager means and arranged to provide data to the manager means, said manager means being arranged to analyze said data from all data networks.

23. The system as claimed in any one of claims 13 to 16, wherein the manager means comprises a single, central manager.

24. The system as claimed in any one of claims 13 to 16, wherein the manager means comprises a multiplicity of independent managers.
